(19) United States
(12) Patent Application Publication
(10) Pub. No.: US 2019/0162149 A1
(43) Pub. Date: May 30, 2019

(54) FUEL INJECTION VALVE

(71) Applicant: DENSO CORPORATION, Kariya-city (JP)

(72) Inventors: Tsukasa YAMASHITA, Kariya-city (JP); Kazufumi SERIZAWA, Kariya-city (JP); Shinji ONISHI, Kariya-city (JP); Daisuke ITOMURA, Kariya-city (JP)

(21) Appl. No.: 16/201,016

(22) Filed: Nov. 27, 2018

(30) Foreign Application Priority Data
Nov. 29, 2017 (JP) 2017-229421

(51) Int. Cl. F02M 63/00

(52) U.S. Cl. CPC F02M 63/0078; F02M 2200/9061; F02M 2200/05

(57) ABSTRACT

A fuel injection valve includes a body that includes an injection hole through which fuel is injected, and a valve element that opens or closes the injection hole. The body includes a metallic base material configured to form the injection hole, a corrosion-resistant layer covering a surface of at least a part of the base material that forms the injection hole and being made of a less corrosive material than the base material, and a diffusion deterring layer located between the base material and the corrosion-resistant layer and made of a material that less easily allows a metal component of the base material to diffuse than the material of the corrosion-resistant layer.

### CROSS REFERENCE TO RELATED APPLICATION

This application is based on Japanese Patent Application No. 2017-229421 filed on Nov. 29, 2017, the disclosure of which is incorporated herein by reference.

### TECHNICAL FIELD

The present disclosure relates to a fuel injection valve that injects fuel.

### BACKGROUND

In regard to a fuel injection valve that injects fuel, which is used in combustion in an internal combustion engine, from an injection hole, condensed water may adhere to a valve body having the injection hole. The valve body may be concernedly corroded by the condensed water adhering thereto. In particular, when a portion having the injection hole in the valve body is corroded, a change in injection characteristics occurs, such as a change in a spray shape or an amount of the fuel injected from the injection hole.

A countermeasure against this issue is disclosed in JP H5-209575 A, in which the outer circumferential surface of the valve body and the inner circumferential surface of the injection hole are chromed to improve corrosion resistance of the valve body.

In a known a technique in the related art, part of exhaust gas from an internal combustion engine is refluxed as a reflux gas into intake air to reduce nitrogen oxide (NOx) as an object of the emission control. Recently, the amount of the reflux gas (EGR amount) tends to be increased with tighter control on exhaust emissions.

However, since the reflux gas contains a large amount of sulfur and nitrogen, increasing the EGR amount causes dissolution of a larger amount of sulfur and nitrogen in the condensed water adhering to the valve body, resulting in accelerated corrosion of the valve body. A measure against corrosion is therefore increasingly required for a recent valve body. The measure is however limitedly improved in the existent structure of the valve body only subjected to chromizing.

### SUMMARY

The present disclosure addresses at least one of the above issues. Thus, it is an objective of the present disclosure to provide a fuel injection valve improved in the measure against corrosion.

To achieve the objective of the present disclosure, there is provided a fuel injection valve including a body that includes an injection hole through which fuel is injected, and a valve element that opens or closes the injection hole. The body includes a metallic base material configured to form the injection hole, a corrosion-resistant layer covering a surface of at least a part of the base material that forms the injection hole and made of a less corrosive material than the base material, and a diffusion deterring layer located between the base material and the corrosion-resistant layer and made of a material that less easily allows a metal component of the base material to diffuse than the material of the corrosion-resistant layer.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a sectional view of a fuel injection valve of a first embodiment;

FIG. 2 is a sectional view of a valve body in FIG. 1;

FIG. 3 is an enlarged view of FIG. 2;

FIG. 4 is an enlarged view of a portion shown by a dot-and-dash line in FIG. 3;

FIG. 5 is a sectional view of a valve body of a second embodiment;

FIG. 6 is a sectional view of a valve body of a third embodiment;

FIG. 7 is a sectional view of a valve body of a fourth embodiment; and

FIG. 8 is a sectional view of a valve body of a fifth embodiment.

### DETAILED DESCRIPTION

Hereinafter, some embodiments will be described with reference to the accompanying drawings. In the embodiments, corresponding components are designated by the same reference numeral, and duplicated description may be omitted. When only a portion of a configuration is described in each embodiment, other portions of the configuration can be described using previous description of a configuration of another embodiment.

### First Embodiment

A fuel injection valve of a first embodiment of the present disclosure injects fuel, which is used in combustion in an internal combustion engine, from an injection hole. The internal combustion engine is a compression ignition diesel engine, and is mounted in a vehicle as a traveling drive source. Fuel (for example, light oil) reserved in an undepicted fuel tank is pressure-fed into a common rail by a high-pressure fuel pump, and then distributed from the common rail into each fuel injection valve 10, and injected into a combustion chamber from the fuel injection valve 10.

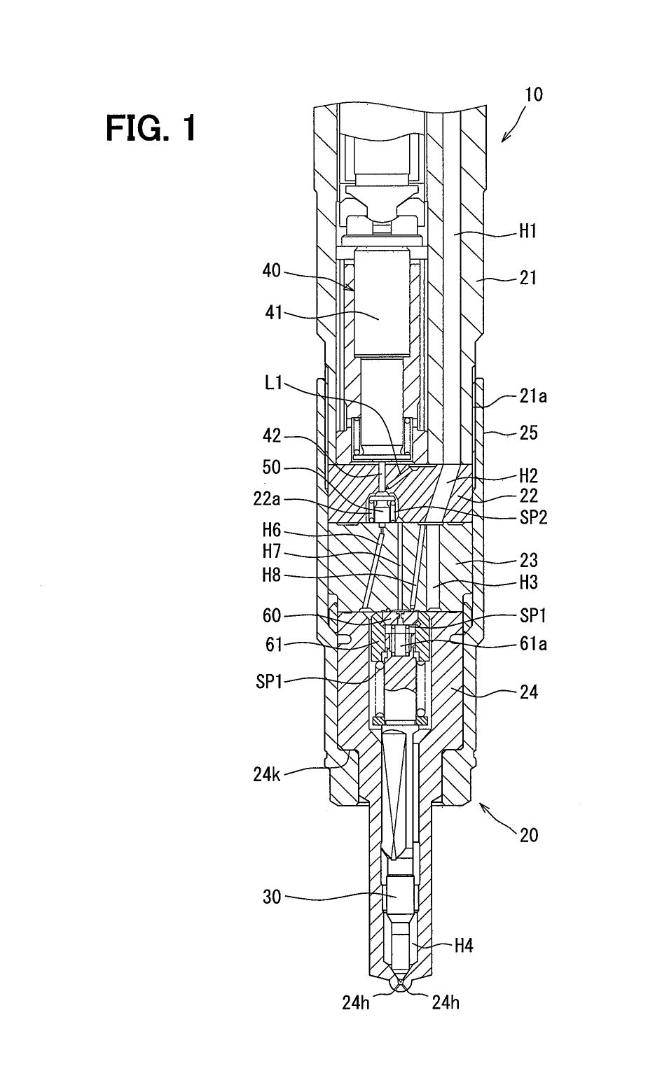

As shown in FIG. 1, the fuel injection valve 10 includes a body 20, a valve needle 30, a drive part 40, a control valve element 50, a control plate 60, and a cylinder 61.

The body 20 includes a plurality of metal components such as a drive part body 21, a valve plate 22, an orifice plate 23, and a valve body 24, which are combined together by a retaining nut 25. Specifically, the retaining nut 25 is fastened to a screw part 21a of the drive part body 21 while being stopped by a stopping part 24k of the valve body 24. Consequently, the valve body 24 and the drive part body 21 are fastened so as to approach each other in an axial direction. As a result, the valve plate 22 and the orifice plate 23 located between the valve body 24 and the drive part body 21 are held by the valve body 24 and the drive part body 21.

The valve needle 30, the control plate 60, and the cylinder 61 are accommodated in the valve body 24, the drive part 40 is accommodated in the drive part body 21, and the control valve element 50 is accommodated in the valve plate 22. Furthermore, high-pressure passages H1, H2, H3, H4, and H5 are formed in the drive part body 21, the valve plate 22, the orifice plate 23, and the valve body 24 so that a high-pressure fuel, which is supplied from a common rail in a distributed manner, flows therethrough.

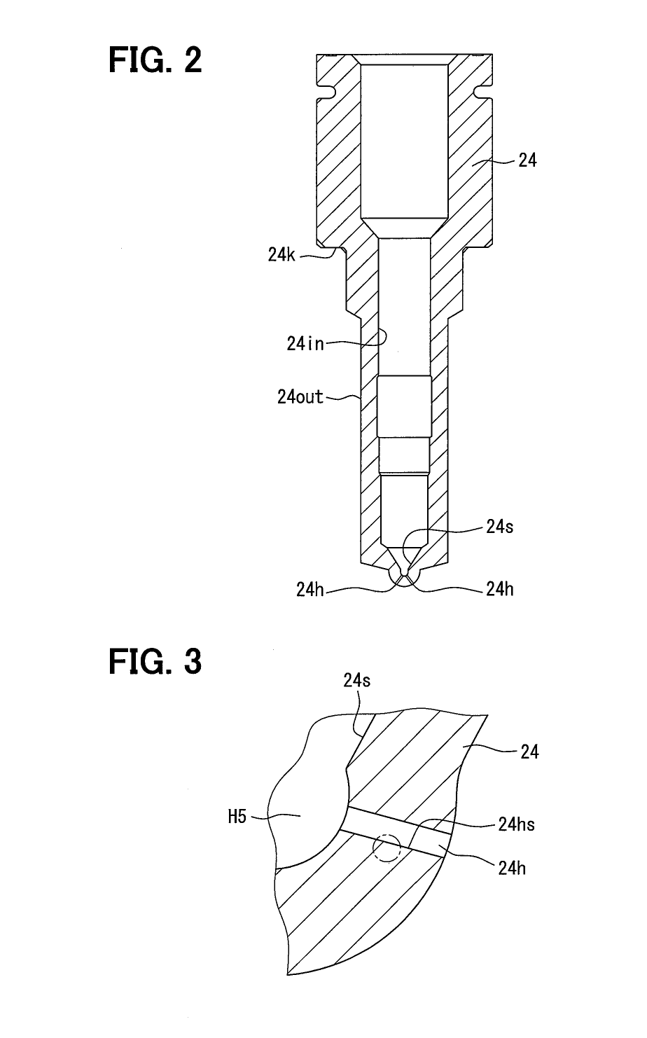

The high-pressure passage H4 within the valve body 24 is a circular passage formed between an outer circumferential surface of the valve needle 30 and an inner wall surface 24in (see FIG. 2) of the valve body 24. The high-pressure passage H5 (see FIG. 3) within the valve body 24 is formed between an end surface of the valve needle 30 and the inner wall surface 24in of the valve body 24. The high-pressure passage H5 is in communication with the downstream side of the high-pressure passage H4, and may be referred to as suck chamber to gather the high-pressure fuel that is annually distributed in the high-pressure passage H4. The valve body 24 has a plurality of injection holes 24h that inject fuel. The high-pressure passage H5 (suck chamber) is in communication with the upstream side of each injection hole 24h, and distributes the high-pressure fuel to the injection hole 24h. The valve body 24 corresponds to “body” having the injection holes 24h, and the valve needle 30 corresponds to “valve element” that opens and closes the injection holes 24h.

The inner wall surface 24in of the valve body 24 has a portion that forms the high-pressure passage H4 and is located directly above the high-pressure passage H5, and the portion serves as a seat surface 24s which the valve needle 30 is seated on or separated from. In a state where the valve needle 30 is lifted up (valve opening operation) and thus separated from the seat surface 24s, the high-pressure passage H4 is opened so that the high-pressure fuel is injected from the injection holes 24h. In a state where the valve needle 30 is lifted down (valve closing operation) and thus seated on the seat surface 24s, the high-pressure passage H4 is closed so that fuel injection from the injection holes 24h is stopped.

The cylinder 61 is accommodated in the valve body 24 while being held between a resilient member SP1 and the orifice plate 23, and the control plate 60 is disposed slidably in the cylinder 61. A control chamber 61a to be filled with the fuel is provided on the counter injection hole-side of the valve needle 30. The control chamber 61a is surrounded by the inner circumferential surface of the cylinder 61, the surface on the injection hole-side of the control plate 60, and the surface on the counter injection hole-side of the valve needle 30.

The valve plate 22 has an accommodation chamber 22a that accommodates the control valve element 50 and a low-pressure passage L1 in communication with the accommodation chamber 22a. The orifice plate 23 has a high-pressure passage H6 that allows the high-pressure passage H4 to communicate with the accommodation chamber 22a, a high-pressure passage H7 that allows the accommodation chamber 22a to communicate with the control chamber 61a, and a high-pressure passage H8 that allows the high-pressure passage H2 to communicate with the control chamber 61a. The control valve element 50 opens and closes communication between the accommodation chamber 22a and the low-pressure passage L1, and between the high-pressure passage H6 and the accommodation chamber 22a. The control plate 60 opens and closes communication between the high-pressure passage H8 and the control chamber 61a.

The drive part 40 is an electromotive actuator, and includes a piezo stack 41 and a rod 42. The piezo stack 41, which is a stack of a plurality of piezo elements, extends upon energization start, and contracts upon energization stop. The rod 42 transmits extension force of the piezo stack 41 to the control valve element 50 and pushes down the control valve element 50.

Operation of the fuel injection valve 10 is now described.

When energization of the piezo stack 41 is started, the control valve element 50 is pushed down by the drive part 40. As a result, the accommodation chamber 22a communicates with the low-pressure passage L1, and communication between the high-pressure passage H6 and the accommodation chamber 22a is blocked. Consequently, the fuel in the control chamber 61a flows out through the high-pressure passage H7, the accommodation chamber 22a, and the low-pressure passage L1 in this order, so that fuel pressure (back pressure) in the control chamber 61a decreases. As a result, the valve needle 30 performs valve opening operation against valve closing force exerted from the resilient member SP1, and the fuel is injected from the injection holes 24h.

When energization of the piezo stack 41 is stopped, the control valve element 50 is pushed up by a resilient component SP2. As a result, communication between the accommodation chamber 22a and the low-pressure passage L1 is blocked, and the high-pressure passage H6 communicates with the accommodation chamber 22a. Consequently, the high-pressure fuel flows into the control chamber 61a from the high-pressure passage H6 through the accommodation chamber 22a and the high-pressure passage H7, so that fuel pressure (back pressure) in the control chamber 61a increases. As a result, the valve needle 30 performs valve closing operation, and the fuel injection from the injection holes 24h is stopped. The control plate 60 performs opening operation immediately after start of fuel flow into the control chamber 61a from the high-pressure passage H7, and thus the high-pressure passage H8 communicates with the control chamber 61a. Consequently, the high-pressure fuel flows into the control chamber 61a from both the high-pressure passages H7 and H8, which prompts an increase in back pressure after energization start, leading to improvement in valve closing response of the valve needle 30.

A portion having the injection holes 24h in the valve body 24 is exposed to the combustion chamber of the internal combustion engine, and subjected to air-fuel mixture before combustion and exhaust gas after combustion. When temperature of the exhaust gas remaining in the combustion chamber lowers after stop of the internal combustion engine, a water component contained in the exhaust gas may be condensed and adhere to the valve body 24. Since the exhaust gas contains nitrogen and sulfur, the condensed water adhering to the valve body 24 also contains nitrogen and sulfur. The valve body 24 requires corrosion resistance against water containing nitrogen and sulfur dissolved therein, i.e., requires to have a property such that the valve body is less likely to undergo an oxidation reaction with acid water. In particularly, the EGR amount recently tends to be increased as described above, and thus high corrosion resistance is required.

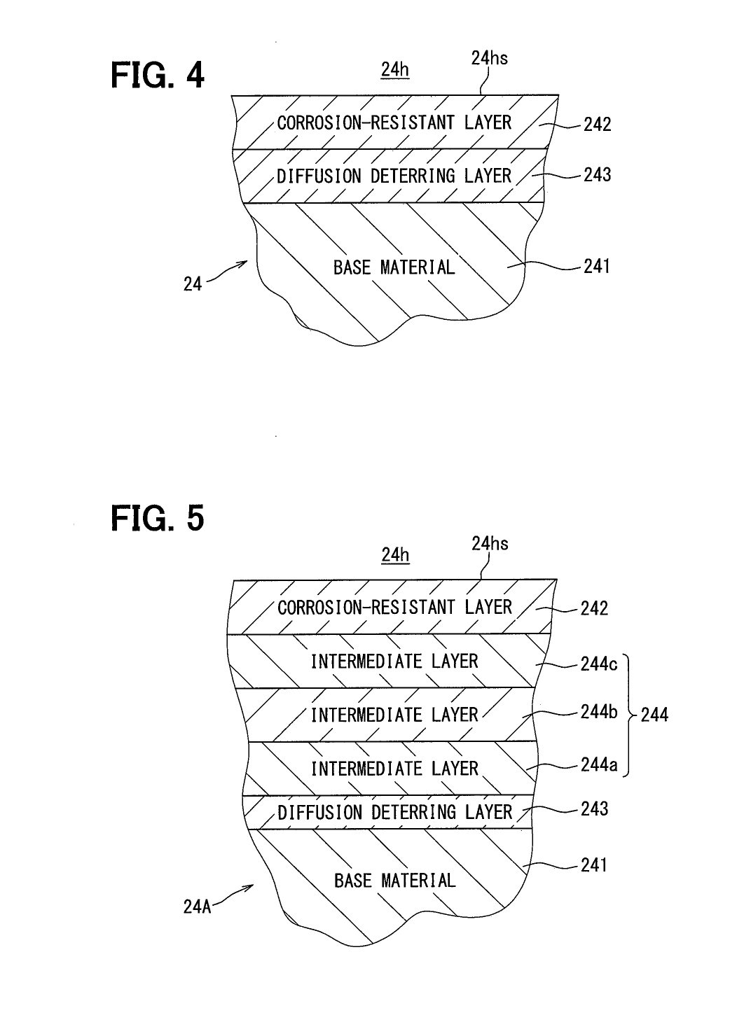

A structure of the valve body 24, which allows the above-described corrosion resistance to be exhibited, is now described with reference to FIG. 4.

As shown in FIG. 4, the valve body 24 includes a base material 241, a corrosion-resistant layer 242, and a diffusion deterring layer 243. The base material 241 includes an iron-based metal mainly containing iron, and is formed into a shape as shown in FIG. 2 by working a cylindrical parent metal. The diffusion deterring layer 243 and the corrosion-resistant layer 242 are stacked on the entire surface of the base material 241, i.e., on the entire inner wall surface 24in and the entire outer wall surface 24out (see FIG. 2).

The corrosion-resistant layer 242 is made of a material that is less corrosive than the base material, for example, tantalum oxide (Ta₂O₅), niobium oxide (Nb₂O₅), and titanium oxide (TiO₂). The material of the corrosion-resistant layer 242 is desirably an amorphous material having an aperiodic atomic arrangement, but may be a crystalline material having a periodic atomic arrangement.

The diffusion deterring layer 243 is located between the base material 241 and the corrosion-resistant layer 242, and is made of a material, in which diffusion of a metal component (for example, iron) of the base material 241 is less likely to occur than in the corrosion-resistant layer 242, for example, aluminum oxide (Al₂O₃). Although “diffusion” is known as a phenomenon where a substance spreads in a gas or liquid, atoms, ions, or defects may also migrate and diffuse in a solid. The diffusion deterring layer 243 is made of a material that is less likely to allow entrance and diffusion of the metal atoms of the base material 241. The material of the diffusion deterring layer 243 is desirably an amorphous material having an aperiodic atomic arrangement, but may be a crystalline material having a periodic atomic arrangement.

The corrosion-resistant layer 242 has a thickness equal to that of the diffusion deterring layer 243. Such thickness is desirably less than 0.5 μm. The corrosion-resistant layer 242 is different in linear expansion coefficient from the base material 241. The linear expansion coefficient of the diffusion deterring layer 243 has a value intermediate between the corrosion-resistant layer 242 and the base material 241. The corrosion-resistant layer 242 is different in Young's modulus from the base material 241. The Young's modulus of the diffusion deterring layer 243 has a value intermediate between the corrosion-resistant layer 242 and the base material 241.

The corrosion-resistant layer 242 and the diffusion deterring layer 243 are each formed by a method of depositing a film on a surface of the base material 241 through a chemical reaction in a vapor phase, i.e., formed by a chemical vapor deposition process. In particular, the corrosion-resistant layer 242 and the diffusion deterring layer 243 are each desirably formed by atomic layer deposition (ALD) as one chemical vapor deposition process. Specifically, first, a heated base material 241 is placed within a chamber. Subsequently, a gaseous material as a precursor of the diffusion deterring layer 243 is loaded in the chamber to form the diffusion deterring layer 243 on the surface of the base material 241. Subsequently, a gaseous material as a precursor of the corrosion-resistant layer 242 is loaded in the chamber to form the corrosion-resistant layer 242 on the surface of the diffusion deterring layer 243.

In this way, since the diffusion deterring layer 243 and the corrosion-resistant layer 242 are stacked on the surface of the base material 241 by a chemical vapor deposition process, the diffusion deterring layer 243 comes into contact with the surface of the base material 241, and the corrosion-resistant layer 242 comes into contact with the surface of the diffusion deterring layer 243. The surface of the corrosion-resistant layer 242 is exposed to each injection hole 24h, and serves as an inner wall surface 24hs of the injection hole 24h.

In this way, in the first embodiment, the valve body 24 includes the base material 241, the corrosion-resistant layer 242, and the diffusion deterring layer 243. The base material 241 is made of a metal having the injection holes 24h. The corrosion-resistant layer 242 covers a surface of at least a portion having the injection holes 24h in the base material 241, and is made of a material less corrosive than the base material 241. The diffusion deterring layer 243 is located between the base material 241 and the corrosion-resistant layer 242, and is made of a material in which diffusion of the metal component of the base material 241 is less likely to occur than in the corrosion-resistant layer 242. The metal component of the base material 241 is therefore prevented from directly diffusing to the corrosion-resistant layer 242. Thus, the diffusion deterring layer 243 deters diffusion of the metal component to the corrosion-resistant layer 242.

In particular, in the first embodiment, since the diffusion deterring layer 243 is in contact with the base material 241, the metal component diffusing from the base material 241 is immediately deterred by the diffusion deterring layer 243. It is therefore possible to improve the effect of deterring diffusion of the metal component of the base material 241 to the corrosion-resistant layer 242.

### Second Embodiment

As shown in FIG. 5, a valve body 24A of a second embodiment has an intermediate layer 244 located between the diffusion deterring layer 243 and the corrosion-resistant layer 242. The intermediate layer 244 is provided by stacking a plurality of films. In FIG. 5, the respective films are indicated by intermediate layers 244a, 244b, and 244c.

The intermediate layers 244a, 244b, and 244c are each formed by a method of depositing a film on a surface of the diffusion deterring layer 243 through a chemical reaction in a vapor phase, i.e., formed by a chemical vapor deposition process. In particular, the intermediate layers 244a, 244b, and 244c are desirably formed by atomic layer deposition (ALD) as one chemical vapor deposition process.

The linear expansion coefficient of the intermediate layer 244 is lower than that of one of the diffusion deterring layer 243 and the corrosion-resistant layer 242, and higher than that of the other of them. For example, when the linear expansion coefficient of the corrosion-resistant layer 242 is higher than that of the diffusion deterring layer 243, the linear expansion coefficient of the intermediate layer 244 is set to a value lower than that of the corrosion-resistant layer 242 (one), and higher than that of the diffusion deterring layer 243 (the other). Furthermore, the linear expansion coefficients of the intermediate layers 244a, 244b, and 244c are set such that the linear expansion coefficient gradually becomes higher as the intermediate layer is closer to one of the diffusion deterring layer 243 and the corrosion-resistant layer 242, and gradually becomes lower as the intermediate layer is closer to the other of them.

The Young's modulus of the intermediate layer 244 is lower than that of one of the diffusion deterring layer 243 and the corrosion-resistant layer 242, and higher than that of the other of them. For example, when the Young's modulus of the corrosion-resistant layer 242 is higher than that of the diffusion deterring layer 243, the Young's modulus of the intermediate layer 244 is set to a value lower than that of the corrosion-resistant layer 242 (one), and higher than that of the diffusion deterring layer 243 (the other). Furthermore, Young's modulus values of the intermediate layers 244a, 244b, and 244c are set such that the value gradually becomes higher as the intermediate layer is closer to one of the diffusion deterring layer 243 and the corrosion-resistant layer 242, and gradually becomes lower as the intermediate layer is closer to the other of them.

Metal components forming the intermediate layer 244 include both a metal component forming the diffusion deterring layer 243 and a metal component forming the corrosion-resistant layer 242. Specifically, first, as in the first embodiment, a gaseous material (first precursor) as a precursor of the diffusion deterring layer 243 is loaded in a chamber, in which the base material 241 is placed, to form the diffusion deterring layer 243 on the surface of the base material 241. Subsequently, both a gaseous material (second precursor) as a precursor of the corrosion-resistant layer 242 and the first precursor are loaded in the chamber to form the first intermediate layer 244a on the surface of the diffusion deterring layer 243.

Subsequently, both the first precursor and the second precursor are loaded in the chamber to form the second intermediate layer 244b on the surface of the first intermediate layer 244a. Subsequently, the first precursor and the second precursor are loaded in the chamber to form the third intermediate layer 244c on the surface of the second intermediate layer 244b. The loading ratio of the first precursor to the second precursor is varied between the formation steps of the intermediate layers 244a, 244b, and 244c to set the linear expansion coefficients and the Young's modulus values as described above. The intermediate layers 244a, 244b, and 244c have the same thickness. Subsequently, the second precursor is loaded in the chamber to form the corrosion-resistant layer 242 on the surface of the intermediate layer 244c.

Since the material of the intermediate layer 244 is a mixture of the precursors of the diffusion deterring layer 243 and the corrosion-resistant layer 242 as described above, corrosion resistance of the intermediate layer 244 is lower than that of the corrosion-resistant layer 242 and higher than that of the diffusion deterring layer 243. The diffusion deterring performance of the intermediate layer 244 is lower than the diffusion deterring layer 243 and higher than the corrosion-resistant layer 242. Corrosion resistance of the intermediate layers 244a, 244b, and 244c gradually becomes lower as the intermediate layer is closer to the diffusion deterring layer 243, and diffusion deterring performance of the intermediate layers 244a, 244b, and 244c gradually becomes lower as the intermediate layer is closer to the corrosion-resistant layer 242.

When the intermediate layer 244 is not provided contrary to the second embodiment, thermal expansion or thermal contraction of the valve body 24A may concernedly cause damage such as separation or cracks at a boundary of the diffusion deterring layer 243 and the corrosion-resistant layer 242 due to a difference in the linear expansion coefficient between the diffusion deterring layer 243 and the corrosion-resistant layer 242. On the other hand, the valve body 24A of the second embodiment has the intermediate layer 244 located between the diffusion deterring layer 243 and the corrosion-resistant layer 242. The linear expansion coefficient of the intermediate layer 244 is lower than that of one of the diffusion deterring layer 243 and the corrosion-resistant layer 242, and higher than that of the other of them. It is therefore possible to reduce a difference in the linear expansion coefficient between adjacent layers, leading to suppression of such a concern of the damage.

Furthermore, for the linear expansion coefficients of the intermediate layers 244a, 244b, and 244c, the linear expansion coefficient gradually becomes higher as the intermediate layer is closer to one of the diffusion deterring layer 243 and the corrosion-resistant layer 242, and gradually becomes lower as the intermediate layer is closer to the other of them. This makes it possible to reduce the difference in the linear expansion coefficient between the intermediate layer 244a and the diffusion deterring layer 243, and also reduce the difference in the linear expansion coefficient between the intermediate layer 244c and the corrosion-resistant layer 242 compared with a case where the intermediate layer 244 as a whole has one linear expansion coefficient. Consequently, the concern of the damage can be promptly suppressed.

When the intermediate layer 244 is not provided contrary to the second embodiment, deformation of the valve body 24A by external force may concernedly cause damage such as separation or cracks at a boundary of the diffusion deterring layer 243 and the corrosion-resistant layer 242 due to a difference in Young's modulus between the diffusion deterring layer 243 and the corrosion-resistant layer 242. On the other hand, in the second embodiment, the Young's modulus of the intermediate layer 244 is lower than that of one of the diffusion deterring layer 243 and the corrosion-resistant layer 242, and higher than that of the other of them. It is therefore possible to reduce a difference in the Young's modulus between adjacent layers, leading to suppression of such a concern of the damage.

Furthermore, for the Young's modulus values of the intermediate layers 244a, 244b, and 244c, the value gradually becomes higher as the intermediate layer is closer to one of the diffusion deterring layer 243 and the corrosion-resistant layer 242, and gradually becomes lower as the intermediate layer is closer to the other of them. This makes it possible to reduce the difference in the Young's modulus between the intermediate layer 244a and the diffusion deterring layer 243, and also reduce the difference in the Young's modulus between the intermediate layer 244c and the corrosion-resistant layer 242 compared with a case where the intermediate layer 244 as a whole has one Young's modulus. Consequently, the concern of the damage can be promptly suppressed.

Furthermore, in the second embodiment, the metal components forming the intermediate layer 244 include both the metal component forming the diffusion deterring layer 243 and the metal component forming the corrosion-resistant layer 242. This makes it possible to easily achieve that the linear expansion coefficient or the Young's modulus of the intermediate layer is lower than that of one of the diffusion deterring layer 243 and the corrosion-resistant layer 242, and higher than that of the other of them.

### Third Embodiment

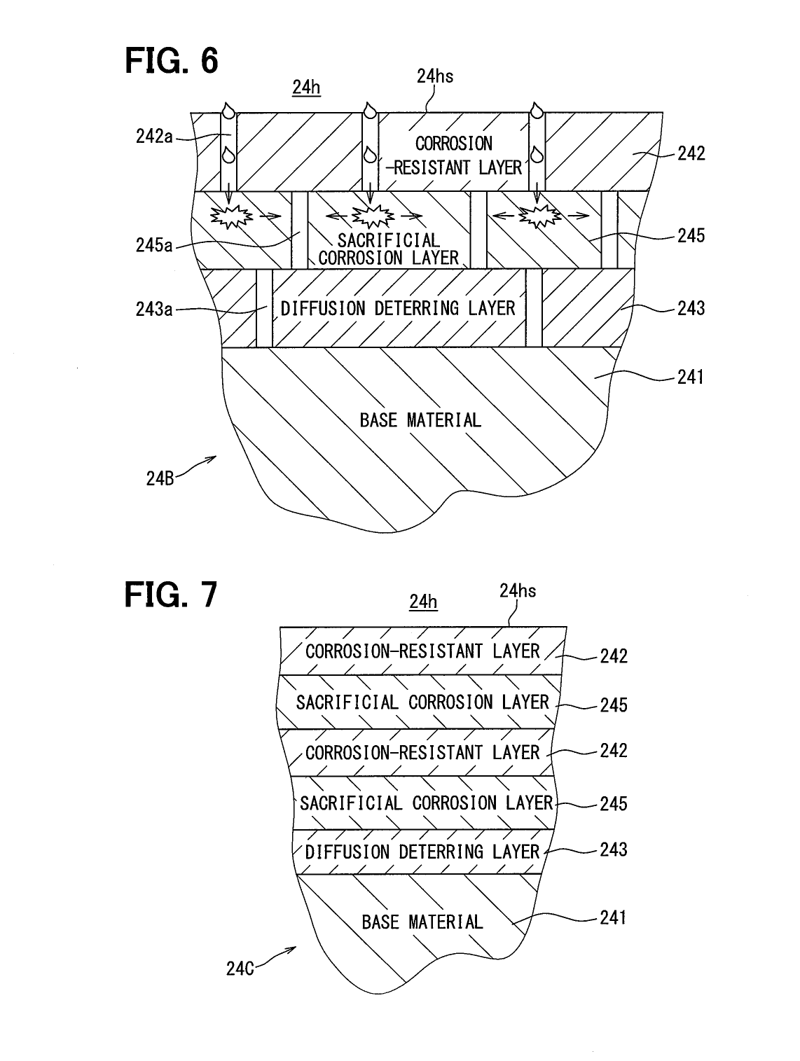

The valve body 24 of the first embodiment has a structure where the diffusion deterring layer 243 and the corrosion-resistant layer 242 are provided on the base material 241 as shown in FIG. 4. On the other hand, a valve body 24B of a third embodiment has a structure where a sacrificial corrosion layer 245 is provided on the base material 241 in addition to the diffusion deterring layer 243 and the corrosion-resistant layer 242 as shown in FIG. 6. The sacrificial corrosion layer 245 is now described in detail.

The sacrificial corrosion layer 245 is made of a metal oxide that is corrosive compared with the corrosion-resistant layer 242. For example, a material of the sacrificial corrosion layer 245 contains the same components as the several types of metal oxides contained in the corrosion-resistant layer 242, but has a mixing ratio of such components set to be different from that of the corrosion-resistant layer 242 so as to be more corrosive than a material of the corrosion-resistant layer 242. Alternatively, the material of the sacrificial corrosion layer 245 contains the same components as the several types of metal oxides contained in the diffusion deterring layer 243, but has a mixing ratio of such components set to be different from that of the diffusion deterring layer 243 so as to be more corrosive than a material of the corrosion-resistant layer 242. Alternatively, the material of the sacrificial corrosion layer 245 mainly contains the same component as the main component (for example, iron) of the base material 241.

In any case, the material of the sacrificial corrosion layer 245 desirably liquates at a hydrogen-ion exponent (PH) of four or less. That is, when a condensed water that arrives at the sacrificial corrosion layer 245 has a PH of 4 or less, the sacrificial corrosion layer 245 is oxidized and liquates by the condensed water. More desirably, the material of the sacrificial corrosion layer 245 liquates at a hydrogen-ion exponent (PH) of two or less.

The sacrificial corrosion layer 245 is formed between the diffusion deterring layer 243 and the corrosion-resistant layer 242. For example, the sacrificial corrosion layer 245 is formed on the base material 241 by a chemical vapor deposition process (for example, ALD) together with the corrosion-resistant layer 242 and the diffusion deterring layer 243. Specifically, first, a heated base material 241 is placed within a chamber. Subsequently, a gaseous material as a precursor of the diffusion deterring layer 243 is loaded in the chamber to form the diffusion deterring layer 243 on the surface of the base material 241. Subsequently, a gaseous material as a precursor of the sacrificial corrosion layer 245 is loaded in the chamber to form the sacrificial corrosion layer 245 on the surface of the diffusion deterring layer 243. Subsequently, a gaseous material as a precursor of the corrosion-resistant layer 242 is loaded in the chamber to form the corrosion-resistant layer 242 on the surface of the sacrificial corrosion layer 245. The sacrificial corrosion layer 245 has a thickness equal to the thickness of the corrosion-resistant layer 242 or the diffusion deterring layer 243.

As shown in FIG. 6, strictly, a defect existing in the corrosion-resistant layer 242 forms a through-hole 242a penetrating in a stacking direction. For example, a portion of the surface of the sacrificial corrosion layer 245, to which the gaseous material as the precursor of the corrosion-resistant layer 242 has not adhered, forms the defect during ALD. The diffusion deterring layer 243 and the sacrificial corrosion layer 245 also have through-holes 243a and 245a, respectively, formed by the defects as with the corrosion-resistant layer 242. In particular, a defect tends to be formed into a film-penetrating shape (through-hole) in one film formed in one step by a chemical vapor deposition process.

However, since the corrosion-resistant layer 242, the sacrificial corrosion layer 245, and the diffusion deterring layer 243 are formed in different steps, the through-hole 242a of the corrosion-resistant layer 242 comes into communication with the through-hole 245a of the sacrificial corrosion layer 245 at a low possibility. Similarly, the through-hole 245a of the sacrificial corrosion layer 245 comes into communication with the through-hole 243a of the diffusion deterring layer 243 at a low possibility.

In this way, the valve body 24B of the third embodiment includes the sacrificial corrosion layer 245 in addition to the diffusion deterring layer 243 and the corrosion-resistant layer 242, and the sacrificial corrosion layer 245 is located between the base material 241 and the corrosion-resistant layer 242. Hence, even when condensed water adhering to the inner wall surface 24hs penetrates the corrosion-resistant layer 242 in a thickness direction through the through-hole 242a of the corrosion-resistant layer 242, such condensed water is subjected to an oxidation reaction in the sacrificial corrosion layer 245 and undergoes a chemical change. This makes it possible to suppress arrival of the condensed water at the diffusion deterring layer 243 through the through-hole 245a of the sacrificial corrosion layer 245. It is therefore possible to suppress oxidation of the diffusion deterring layer 243 by the condensed water, and thus suppress deterioration of the diffusion deterring function of the diffusion deterring layer 243. Furthermore, it is possible to suppress arrival of the condensed water at the base material 241 through the through-hole 243a of the diffusion deterring layer 243. It is therefore possible to suppress oxidation of the base material 241 by the condensed water, and thus suppress corrosion of the base material 241.

In short, the sacrificial corrosion layer 245 is corroded prior to the base material 241, so that the amount of the condensed water, which penetrates the corrosion-resistant layer 242 and arrives at the base material 241, is decreased in the sacrificial corrosion layer 245. This makes it possible to suppress corrosion of the diffusion deterring layer 243 and the base material 241.

When the base material 241 is corroded by the condensed water, a surface of the base material 241 on a side close to the corrosion-resistant layer 242 is greatly hollowed by the corrosion. The diffusion deterring layer 243, the sacrificial corrosion layer 245, and the corrosion-resistant layer 242 stacked in such a hollowed portion, are then rises and easily fall off from the base material 241. When the layers thus fall off from the base material 241, the shape of the inner wall surface 24hs of the injection hole 24h is changed, leading to a change in injection characteristics such as a change in a spray shape or injection amount of the fuel injected from the injection hole 24h. With regard to such a problem, according to the third embodiment, corrosion of the base material 241 can be suppressed by providing the sacrificial corrosion layer 245 as described above, making it possible to suppress the change in injection characteristics due to falling off of each layer. The thickness of the sacrificial corrosion layer 245 is extremely small compared with a thickness dimension of the base material 241. Hence, the corroded sacrificial corrosion layer 245 is not greatly hollowed unlike the corroded base material 241; hence, the corrosion-resistant layer 242 stacked in the hollowed portion falls off at a low possibility.

Furthermore, in the third embodiment, the material of the sacrificial corrosion layer 245 liquates at a hydrogen-ion exponent of four or less. Hence, the condensed water is easily subjected to an oxidation reaction in the sacrificial corrosion layer 245, which makes it possible to reduce a possibility that the condensed water arrives at the diffusion deterring layer 243 and the base material 241 while being not subjected to the oxidation reaction in the sacrificial corrosion layer 245.

### Fourth Embodiment

The valve body 24B of the third embodiment includes one corrosion-resistant layer 242 and one sacrificial corrosion layer 245. On the other hand, a valve body 24C of a fourth embodiment as shown in FIG. 7 includes a plurality of sacrificial corrosion layers 245 and a plurality of corrosion-resistant layers 242, which are alternately disposed in a stacking manner.

Hence, the fourth embodiment makes it possible to further reduce a possibility of arrival of the condensed water at the diffusion deterring layer 243 and the base material 241. Since the through-holes 242a and 245a formed in the respective layers come into direct communication with each other at a low possibility, the possibility of arrival of the condensed water can be reduced compared with the case where one corrosion-resistant layer 242 and one sacrificial corrosion layer 245 are provided with an increased thickness.

### Fifth Embodiment

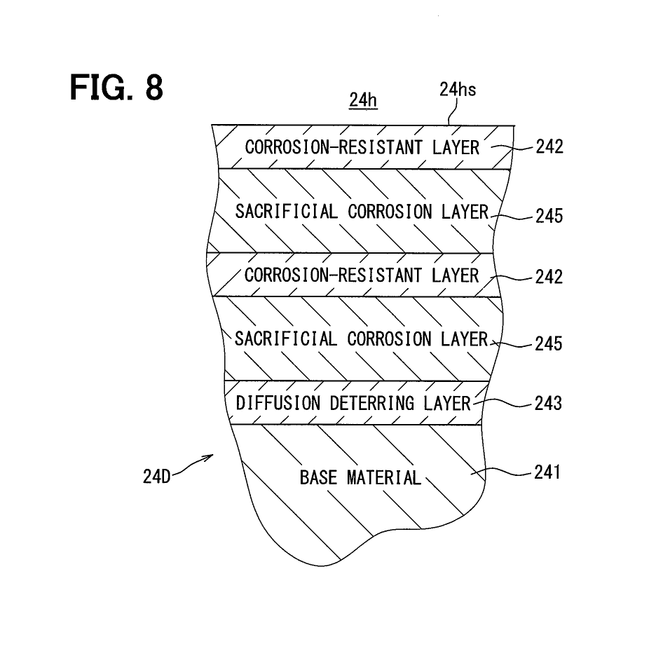

In the valve body 24C of the fourth embodiment, the corrosion-resistant layer 242, the diffusion deterring layer 243, and the sacrificial corrosion layer 245 have the same thickness. On the other hand, a valve body 24D of a fifth embodiment shown in FIG. 8 is designed such that thickness of the sacrificial corrosion layer 245 is set larger than thickness of each of the corrosion-resistant layer 242 and the diffusion deterring layer 243.

Hence, the fifth embodiment makes it possible to further reduce a possibility of arrival of the condensed water at the diffusion deterring layer 243 and the base material 241. In a possible modification of the fifth embodiment, thickness of each sacrificial corrosion layer 245 may be set small compared with each of the corrosion-resistant layer 242 and the diffusion deterring layer 243. Thicknesses of the plurality of the sacrificial corrosion layers 245 may be equal to or different from one another.

### Sixth Embodiment

In the valve body 24 or 24A having no sacrificial corrosion layer 245 as shown in FIG. 4 or 5, the diffusion deterring layer 243 of a valve body of a sixth embodiment is made of a material that is more corrosive than the corrosion-resistant layer 242. That is, the material of the diffusion deterring layer 243 of the sixth embodiment includes a material, in which diffusion of the metal component (for example, iron) of the base material 241 is less likely to occur than in the corrosion-resistant layer 242, and is more corrosive than the corrosion-resistant layer 242.

For example, the material of the diffusion deterring layer 243 contains aluminum oxide (Al₂O₃) allowing the layer 243 to exhibit the diffusion deterring function, and iron (Fe) allowing the layer 243 to be corrosive. In short, the sixth embodiment allows the diffusion deterring layer 243 to exhibit the function of the sacrificial corrosion layer 245 shown in FIG. 6, 7, or 8. The material of the diffusion deterring layer 243 desirably liquates at a hydrogen-ion exponent (PH) of four or less (more preferably two or less).

In this way, the sixth embodiment makes it possible to decrease the amount of the condensed water by the diffusion deterring layer 243 while having no sacrificial corrosion layer 245, and thus reduce a possibility that the condensed water adhering to the inner wall surface 24hs arrives at the base material 241 while being not subjected to an oxidation reaction in the diffusion deterring layer 243.

Although the plurality of embodiments of the present disclosure have been described hereinbefore, not only a combination of configurations specified in description of the embodiments but also a partial combination of configurations in the embodiments can be used while being not specified as long as such a combination is not particularly disadvantageous. An unspecified combination of configurations described in the embodiments and modifications is also disclosed in the following description. Modifications of the embodiments are now described.

While the specific example of the material of the base material 241 includes the iron-based metal in the above-described embodiments, a further specific example includes case hardening steel, stainless steel, tool steel, and aluminum. The base material 241 may or may not necessarily be subjected to heat treatment such as hardening, carburizing, and nitriding. The base material 241 may be made of a metal oxide.

The thickness of the corrosion-resistant layer 242 may be smaller or larger than the thickness of the diffusion deterring layer 243 while being equal to that in the first embodiment.

In the above-described embodiments, the component is less diffusible in the material of the diffusion deterring layer 243 than in the material of the corrosion-resistant layer 242. In other words, when an index of diffusibility of the metal component of the base material 241 is defined as diffusion coefficient, and when the metal component is more diffusible with a larger value of the diffusion coefficient, the diffusion deterring layer 243 has a smaller diffusion coefficient than the corrosion-resistant layer 242. Such a relationship of the diffusion coefficient may be true in an atmosphere of 500° C. or lower. In addition, the diffusion coefficient relationship may be true in the case where the base material 241 is made of an iron-based metal.

In the above-described embodiments, the corrosion-resistant layer 242 and the diffusion deterring layer 243 are each formed by an ALD process. On the other hand, the layers may each be formed by a chemical vapor deposition process other than ALD, or by a process other than the chemical vapor deposition process, for example, by plating.

In the above-described embodiments, the diffusion deterring layer 243 and the corrosion-resistant layer 242 are provided on the entire surface of the base material 241, i.e., on the entire inner wall surface 24in and the entire outer wall surface 24out (see FIG. 2). On the other hand, the layers may not necessarily be provided in a portion covered with the retaining nut 25 in the valve body 24. The diffusion deterring layer 243 and the corrosion-resistant layer 242 are provided in at least a portion having the injection holes 24h in the valve body 24.

In the above-described embodiments, the corrosion-resistant layer 242 and the diffusion deterring layer 243 are provided for the fuel injection valve 10 as a subject, which is mounted in an internal combustion engine having a function of refluxing a part of exhaust gas into intake air. On the other hand, the corrosion-resistant layer 242 and the diffusion deterring layer 243 may be provided for a fuel injection valve as a subject, which is mounted in an internal combustion engine that does not have such a refluxing function.

Although the valve body 24A of the second embodiment has the plurality of intermediate layers 244, the valve body 24A may have one intermediate layer 244. Although the intermediate layers 244 have the gradually varying linear expansion coefficients or Young's modulus in the second embodiment, the intermediate layers 244 may have a fixed linear expansion coefficient or Young's modulus.

In the above-described embodiments, the diffusion deterring layer 243 is provided while being in contact with the base material 241.

On the other hand, another layer may be provided between the diffusion deterring layer 243 and the base material 241 so that the diffusion deterring layer 243 is not in contact with the base material 241.

Characteristics of the fuel injection valve 10 of the above embodiments can be described as follows.

A fuel injection valve in an aspect of the present disclosure includes a body 24, 24A, 24B, 24C, 24D that includes an injection hole 24h through which fuel is injected, and a valve element 30 that opens or closes the injection hole 24h. The body 24, 24A, 24B, 24C, 24D includes a metallic base material 241 configured to form the injection hole 24h, a corrosion-resistant layer 242 covering a surface of at least a part of the base material 241 that forms the injection hole 24h and being made of a less corrosive material than the base material 241, and a diffusion deterring layer 243 located between the base material 241 and the corrosion-resistant layer 242 and made of a material that less easily allows a metal component of the base material 241 to diffuse than the material of the corrosion-resistant layer 242.

When the diffusion deterring layer 243 is not provided contrary to the above-described aspect so that the corrosion-resistant layer 242 is directly provided on the surface of the base material 241, a phenomenon of “diffusion” occurs so that the metal component (for example, iron) of the base material 241 moves to the corrosion-resistant layer 242. The inventors have found that occurrence of such diffusion strictly leads to deterioration in corrosion-resistant performance of the corrosion-resistant layer 242. In particular, such a slight deterioration is not negligible in recent years in which a demand for a measure against corrosion is increased with an increase in the EGR amount as described above.

According to such a finding, the fuel injection valve 10 in the above-described aspect has the diffusion deterring layer 243 that is located between the base material 241 and the corrosion-resistant layer 242 and made of the material, in which diffusion of the metal component of the base material 241 is less likely to occur than in the material of the corrosion-resistant layer 242.

Diffusion of the metal component of the base material 241 is therefore suppressed by the diffusion deterring layer 243, making it possible to suppress diffusion of the metal component up to the corrosion-resistant layer 242, and thus suppress deterioration in corrosion-resistant performance of the corrosion-resistant layer 242 due to the diffusion.

While the present disclosure has been described with reference to embodiments thereof, it is to be understood that the disclosure is not limited to the embodiments and constructions. The present disclosure is intended to cover various modification and equivalent arrangements. In addition, the various combinations and configurations, other combinations and configurations, including more, less or only a single element, are also within the spirit and scope of the present disclosure.

What is claimed is:

1. A fuel injection valve comprising:
a body that includes an injection hole through which fuel is injected; and
a valve element that opens or closes the injection hole, wherein the body includes:
a metallic base material configured to form the injection hole;
a corrosion-resistant layer covering a surface of at least a part of the base material that forms the injection hole and being made of a less corrosive material than the base material; and
a diffusion deterring layer located between the base material and the corrosion-resistant layer and made of a material that less easily allows a metal component of the base material to diffuse than the material of the corrosion-resistant layer.

2. The fuel injection valve according to claim 1, wherein:
the body further includes an intermediate layer located between the diffusion deterring layer and the corrosion-resistant layer; and
a linear expansion coefficient of the intermediate layer is lower than a linear expansion coefficient of one of the diffusion deterring layer and the corrosion-resistant layer and is higher than a linear expansion coefficient of the other one of the diffusion deterring layer and the corrosion-resistant layer, or a Young's modulus of the intermediate layer is lower than a Young's modulus of the one of the diffusion deterring layer and the corrosion-resistant layer and is higher than a Young's modulus of the other one of the diffusion deterring layer and the corrosion-resistant layer.

3. The fuel injection valve according to claim 2, wherein the linear expansion coefficient or the Young's modulus of the intermediate layer gradually becomes higher as the intermediate layer is located closer to the one of the diffusion deterring layer and the corrosion-resistant layer, and gradually becomes lower as the intermediate layer is located closer to the other one of the diffusion deterring layer and the corrosion-resistant layer.

4. The fuel injection valve according to claim 2, wherein a metal component that is formed into the intermediate layer includes both a metal component that is formed into the diffusion deterring layer and a metal component that is formed into the corrosion-resistant layer.

5. The fuel injection valve according to claim 1, wherein the diffusion deterring layer is in contact with the base material.

6. The fuel injection valve according to claim 1, wherein the material of the diffusion deterring layer is more corrosive than the material of the corrosion-resistant layer.

7. The fuel injection valve according to claim 1, wherein:
the body further includes a sacrificial corrosion layer made of a material more corrosive than the corrosion-resistant layer; and
the sacrificial corrosion layer is located between the base material and the corrosion-resistant layer.

8. The fuel injection valve according to claim 7, wherein the material of the sacrificial corrosion layer liquates out at a hydrogen-ion exponent of four or less.

9. The fuel injection valve according to claim 7, wherein:
the sacrificial corrosion layer of the body is one of a plurality of sacrificial corrosion layers;
the corrosion-resistant layer of the body is one of a plurality of corrosion-resistant layers; and
the plurality of corrosion-resistant layers and the plurality of sacrificial corrosion layers are arranged in an alternately stacked manner.
